(19) United States
(12) Patent Application Publication
(10) Pub. No.: US 2026/0039162 A1
(43) Pub. Date: Feb. 5, 2026

(54) WEDGE WITH AUXILIARY TOOL METHOD FOR MECHANICAL MAGNET RETENTION IN ELECTRIC MACHINES

(71) Applicant: FCA US LLC, Auburn Hills, MI (US)

(72) Inventors: Reza Ghafoori-Ahangor, Auburn Hills, MI (US); Dhafar Al-Ani, Auburn Hills, MI (US)

(21) Appl. No.: 18/788,398

(22) Filed: Jul. 30, 2024

(51) Int. Cl. H02K 1/28; B60K 1/00; H02K 1/276; H02K 15/03

(52) U.S. Cl. CPC H02K 1/28; H02K 1/276; H02K 15/03; B60K 1/00

(57) ABSTRACT

An electric machine for powering an electric vehicle includes a rotor, a plurality of first rotor laminations, and a plurality of second rotor laminations. The rotor is configured to rotate relative to a stator to drive a rotor shaft and at least one drive wheel of the electric vehicle, the rotor defining at least a first rotor slot configured to receive a magnet therein. The plurality of first rotor laminations stacked upon each other each having a first pattern. The plurality of second rotor laminations each have a second pattern, distinct from the first pattern, and have a retention mechanism defined thereon. The plurality of second rotor laminations are configured to deflect upon advancement of an auxiliary tool into the plurality of second rotor laminations at the respective retention mechanisms, the respective retention mechanisms deflecting into the magnet creating a retention load retaining the magnet within the rotor slot.

### FIELD

The present application relates generally to electric drive modules for electric vehicles and, more particularly, to a mechanical retention configuration and related method for retaining magnets in electric machines.

### BACKGROUND

Different types of electric vehicles, including mild hybrid electric vehicles (mHEV's), plug-in hybrid electric vehicles (PHEV's), battery electric vehicles (BEV's), and extended-range battery electric vehicles (EREV's), rely on electric machines for propulsion as a main source of torque, which generates the necessary power for vehicle propulsion. Electrical machines that include a permanent magnet in the rotor's electric steel lamination stacks is called an interior permanent magnet (IPM). In some instances, particularly at higher speed electric machines, it can be challenging to retain the permanent magnets in the rotor lamination stacks. Prior art methods of retaining permanent magnets in the rotor laminations include mold injection, adhesives, mold transfer, wavy springs, punching and other retention strategies that each present various drawbacks. In this regard, while existing retention configurations can be satisfactory, there remains a need for improvement in the relevant art.

### SUMMARY

In accordance with one example aspect of the invention, an electric machine for powering an electric vehicle includes a rotor, a plurality of first rotor laminations, and a plurality of second rotor laminations. The rotor is configured to rotate relative to a stator to drive a rotor shaft and at least one drive wheel of the electric vehicle, the rotor defining at least a first rotor slot configured to receive a magnet therein. The plurality of first rotor laminations stacked upon each other each having a first pattern. The plurality of second rotor laminations each have a second pattern, distinct from the first pattern, the plurality of second rotor laminations each having a retention mechanism wedge defined thereon that extends generally into the first rotor slot. The plurality of second rotor laminations are configured to deflect upon advancement of an auxiliary tool into the plurality of second rotor laminations at the respective retention mechanisms, the respective retention mechanisms deflecting into the magnet creating a retention load retaining the magnet within the rotor slot.

In examples, the auxiliary tool comprises a first auxiliary tool, wherein the plurality of first rotor laminations do not deflect upon the advancement of the first auxiliary tool into the plurality of second rotor laminations.

In examples, the plurality of first rotor laminations outnumber the plurality of second laminations.

In other examples, the second rotor lamination defines an edge at the rotor slot, wherein the retention mechanism deflects causing the retention load of the magnet against the edge.

In other implementations, the auxiliary tool is configured to be advanced in a direction parallel to the rotor slot and into the respective retention mechanisms.

In examples, a second rotor lamination of the plurality of second rotor laminations is interleaved between multiple first rotor laminations of the plurality of first rotor laminations.

In other examples, the auxiliary tool comprises a second auxiliary tool having steps configured thereon, wherein the plurality of second rotor laminations align with the steps and deflect upon the advancement, wherein the first rotor laminations do not deflect upon the advancement of the second auxiliary tool.

A method is provided for assembling a rotor configured for use in an electric motor for powering and electric vehicle, the rotor configured to rotate relative to a stator to drive a rotor shaft and at least one drive wheel of the electric vehicle, the rotor defining at least a first rotor slot configured to receive a magnet therein. In one example implementation, the method includes: arranging a plurality of first rotor laminations stacked upon each other, each having a first pattern; arranging a second rotor lamination between adjacent first rotor laminations of the plurality of first rotor laminations, the second rotor lamination having a second pattern distinct from the first pattern, the second pattern including a retention mechanism defined thereon that extends generally into the first rotor slot; inserting a magnet into the rotor slot; and advancing an auxiliary tool toward the first and second rotor laminations, wherein the plurality of second rotor laminations are deflected upon the advancing, the respective retention mechanisms deflecting into the magnet creating a retention load retaining the magnet within the rotor slot.

In examples of the method, the auxiliary tool comprises a first auxiliary tool, wherein the plurality of first rotor laminations do not deflect upon the advancement of the first auxiliary tool into the plurality of second rotor laminations.

In examples of the method, the plurality of first rotor laminations outnumber the plurality of second laminations.

In other examples of the method, the second rotor lamination defines an edge at the rotor slot, wherein the retention mechanism deflects causing the retention load of the magnet against the edge.

In additional examples of the method, the auxiliary tool is configured to be advanced in a direction parallel to the rotor slot and into the respective retention mechanisms.

In other examples of the method, a second rotor lamination of the plurality of second rotor laminations is interleaved between multiple first rotor laminations of the plurality of first rotor laminations.

In additional examples of the method, the auxiliary tool comprises a second auxiliary tool having steps configured thereon, wherein the plurality of second rotor laminations align with the steps and deflect upon the advancing, wherein the first rotor laminations do not deflect upon the advancement of the second auxiliary tool.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module that incorporates a mechanical arrangement for retaining magnets in a rotor lamination stack, in accordance with the principles of the present application;

FIG. 2 is a rotor laminations stack and magnet assembly used in an electric machine of the electric drive module shown in FIG. 1, in accordance with the principles of the present application;

FIG. 3 is a detail view of a rotor lamination showing a gap between the magnet and rotor slot, in accordance with the principles of the present application;

FIG. 4 is a schematic illustration of a wedge shaped retention mechanism that is urged between the magnet and the rotor lamination at the gap in accordance with the principles of the present application;

FIG. 5A is a front perspective view of a first auxiliary tool used to urge the wedge shaped retention mechanism between the magnet and the rotor lamination in accordance with the principles of the present application;

FIG. 5B is a plan view of a first lamination pattern in the rotor, the first lamination presenting a geometry that does not interface with the first auxiliary tool of FIG. 5A in accordance with the principles of the present application;

FIG. 5C is a plan view of a second lamination pattern in the rotor, the second lamination presenting a geometry that does interface with the first auxiliary tool of FIG. 5A, the auxiliary tool of FIG. 5A shown deflecting a retention mechanism toward the magnet such that a wedge creates a load in two directions between the magnet and the rotor slot edge in accordance with the principles of the present application;

FIG. 6A is a front perspective view of a second auxiliary tool having steps configured thereon in accordance with the principles of the present application;

FIG. 6B is a plan view of the second auxiliary tool of FIG. 6A deflecting only retention mechanisms configured on lamination layers that are aligned with the steps of the second auxiliary tool toward the magnet such that a wedge creates a load in two directions between the magnet and the rotor slot edge, the second auxiliary tool not deflecting any of the lamination layers that are not aligned with the steps in accordance with the principles of the present application;

FIG. 7A is a plan view of a section of a rotor lamination stack including a first lamination layer and a second lamination layer, wherein the first auxiliary tool is positioned adjacent the second lamination layer before deflection of the retention mechanism on the second lamination layer toward the magnet in accordance with the principles of the present application;

FIG. 7B is a plan view of the section of the rotor lamination stack of FIG. 7A and shown subsequent to the first auxiliary tool deflecting only the second lamination layer such that the retention mechanism on the second lamination layer deflects toward the magnet and the first lamination layer remains unmoved in accordance with the principles of the present application;

FIG. 8A is a plan view of a section of a rotor lamination stack including a plurality of first and second lamination layers, wherein a first auxiliary tool is positioned adjacent the plurality of second lamination layers before deflection of the retention mechanisms on the second lamination layers toward the magnet in accordance with the principles of the present application;

FIG. 8B is a plan view of the section of a rotor lamination stack shown in FIG. 8A, subsequent to the first auxiliary tool deflecting only the second lamination layers such that the retention mechanisms on the second lamination layers deflect toward the magnet and the first lamination layers remain unmoved in accordance with the principles of the present application;

FIG. 9A is a plan view of a section of a rotor lamination stack including a plurality of first lamination layers, wherein a second auxiliary tool is positioned adjacent the plurality of first lamination layers, the second auxiliary tool having steps configured thereon before deflection of the selected retention mechanisms on the first lamination layers toward the magnet in accordance with the principles of the present application; and

FIG. 9B is a plan view of the section of a rotor lamination stack shown in FIG. 9A, subsequent to the second auxiliary tool deflecting only the first lamination layers aligned with the steps such that the retention mechanisms on the first lamination layers deflect toward the magnet and the first lamination layers not aligned with the steps remain unmoved in accordance with the principles of the present application.

### DETAILED DESCRIPTION

As noted above, electric machines are used in various types of electrified vehicles to generate the necessary power for vehicle propulsion. Electrical machines include rotor lamination stacks that incorporates magnets disposed within slots defined in the rotor lamination stacks. In some circumstances, it can be challenging to retain the magnets in the rotor lamination stacks. For example, during assembly on a production line it is important to adequately retain the magnets in the rotor lamination stacks. Furthermore, during operation of the rotor in an electric machine, adequate retention is essential for accounting for the centrifugal force seen during rotation. Prior solutions for retaining magnets in the rotor lamination slots included adhesive, mold injection, mold transfer, retaining sleeves, wavy springs, tab and groove, and punching.

In some existing arrangements, the magnets in the rotor laminations stack are retained in place by biasing members such as wavy springs that are inserted between the magnets and the rotor slot edges. These wavy springs are formed of a metal having shape memory and can be inserted as ductile flat sheets at low temperature, becoming stiff wavy springs at normal ambient temperatures. The flexibility of the wavy spring allows it to absorb minor shocks and vibrations, protecting the magnet from damage due to sudden impacts or movements. Wavy springs can have a limited load-bearing capacity compared to the present disclosure, which could be a concern in applications requiring high retention force. Over time, repeated compression and expansion of the wavy spring can lead to wear and fatigue, potentially reducing the effectiveness of the wavy spring. Furthermore, the design of the wavy spring requires additional space around the magnet, which could be a limitation in compact or tight-fitting applications. Moreover, wavy springs are sensitive to changes in temperature or humidity, which could affect their performance and reliability in certain environments.

In other prior arrangements, tab and grooves are incorporated into selected rotor laminations which undergo deformation upon magnet insertion. Tab and grooves provide secure retention on the magnet and minimize the risk of movement of the magnet. Tab and grooves have a lower load-bearing capacity compared to the instant disclosure, which could be a concern in applications requiring high speed. There are multiple lamination layouts for incorporating tab and grooves making the assembly process complex.

In another prior art configuration, a rotor slot's edge undergoes plastic deformation, effectively retaining the magnet through this deformation. The punching method can cause damage to the magnet or surrounding components if not executed with precision or if excessive force is applied. Although there is generally good process control during punching, there is potential for pre-stress and load on the magnets. Depending on the material and thickness of the stack, punched retention features are limited to the surface of the stack and does not consider retention of the magnets within the stack depth. Moreover, aligning and positioning the punch tool accurately during assembly requires additional time and effort, especially for complex designs or tight tolerances.

According to the principles of the present application, a mechanical retention pattern and related method for retaining magnets in electric machines is provided. The retention pattern includes targeted deflection of only selected layers of the lamination stack such that retention mechanisms are deflected into the gap defined between the magnet and the rotor slot edge by an auxiliary tool. The deflection of the retention mechanisms creates loads on the magnet in two directions and retains the magnet within the rotor slot. The auxiliary tool is introduced into the magnet pocket and advanced toward the lamination stack applying load to select layers of the lamination stack. In one embodiment, the stack includes a plurality of first lamination layers having first geometries and a plurality of second lamination layers having a second geometry. A first auxiliary tool deflects only the plurality of second lamination layers such that respective retention mechanisms on the second lamination layers deflect toward the magnet and the plurality of first lamination layers remains unmoved. In a second embodiment, the stack includes a plurality of first lamination layers all having a common geometry. A second auxiliary tool having steps configured thereon. The second auxiliary tool deflects only first lamination layers aligned with the steps such that retention mechanisms on the first lamination layers deflect toward the magnet and the first lamination layers not aligned with the steps remain unmoved. Additionally, the magnet can retain from different points in the depth of each stack. The configurations and methods described herein is applicable to all types of electric machines (electric machine and generator) with magnets.

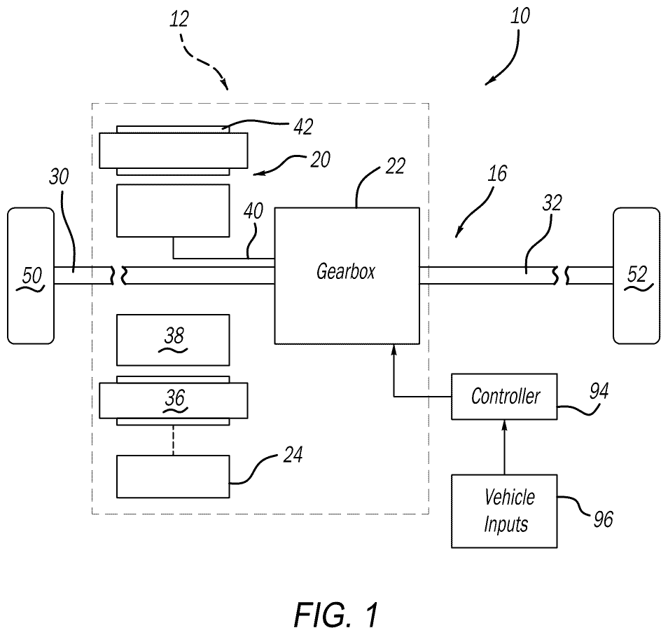

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24. The electric machine 20 is selectively connectable via the PIM 24 to a high voltage battery system (not shown) for powering the electric machine 20. The gearbox assembly 22 is configured to transfer the generated drive torque to the driveline 16, including a first or left axle shaft 30 and a second or right axle shaft 32. In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle.

In the example embodiment, the electric machine 20 generally includes a stator 36, a rotor 38, and a rotor output shaft 40. The stator 36 is fixed (e.g., to a housing 42) and the rotor 38 is configured to rotate relative to the stator 36 to drive the rotor shaft 40 and thus the vehicle axles 30, 32 (e.g., half shafts) and therefore respective drive wheels 50, 52. In the illustrated example, the EDM 12 is configured for a rear axle (axles 30, 32) of the vehicle 10, but it will be appreciated that the systems and methods described herein are equally applicable to a front axle EDM configuration, and can be replicated on the front and rear axles for four wheel drive.

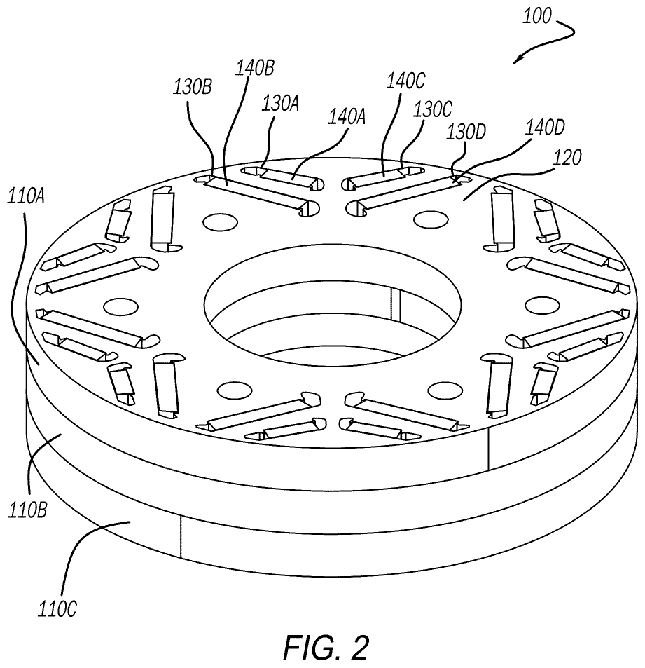

With reference now to FIG. 2, a rotor laminations stack and magnet assembly used in an electric machine of the electric drive module shown in FIG. 1 is generally identified at reference numeral 100. The exemplary rotor laminations stack and magnet assembly 100 includes a first stack 110A, a second stack 110B and a third stack 110C. It is appreciated that more layers or stacks may be provided. A rotor lamination 120 generally defines various pockets or slots 130A, 130B, 130C, 130D, etc. configured to receive complementary magnets 140A, 140B, 140C, 140D, etc.

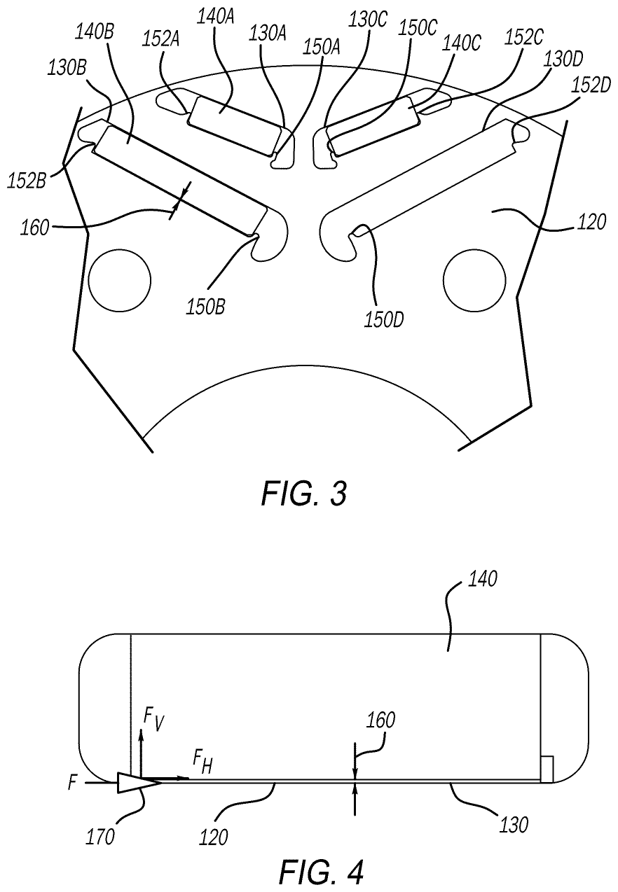

With additional reference to FIGS. 3 and 4, the rotor laminations stack and magnet assembly 100 will be further described. Various stoppers 150A-150D and 152A-152D are arranged on the rotor lamination 120 that extend generally in a direction into the respective slot(s) 130A, 130B, 130C, 130D, etc. In general, a gap 160 is defined between the respective magnets 140 and rotor lamination 120. FIG. 4 shows a schematic illustration of a wedge shaped retention mechanism 170 that is urged between the magnet 140 and the rotor lamination 120 at the gap 160. The wedge shaped retention mechanism 170 receives an input force F and creates a vertical load F_{V} and a horizontal load F_{H} effectively pushing and retaining the magnet within the rotor slot 130. The wedge shaped retention mechanism 170 schematically represents the various retention mechanisms disclosed herein.

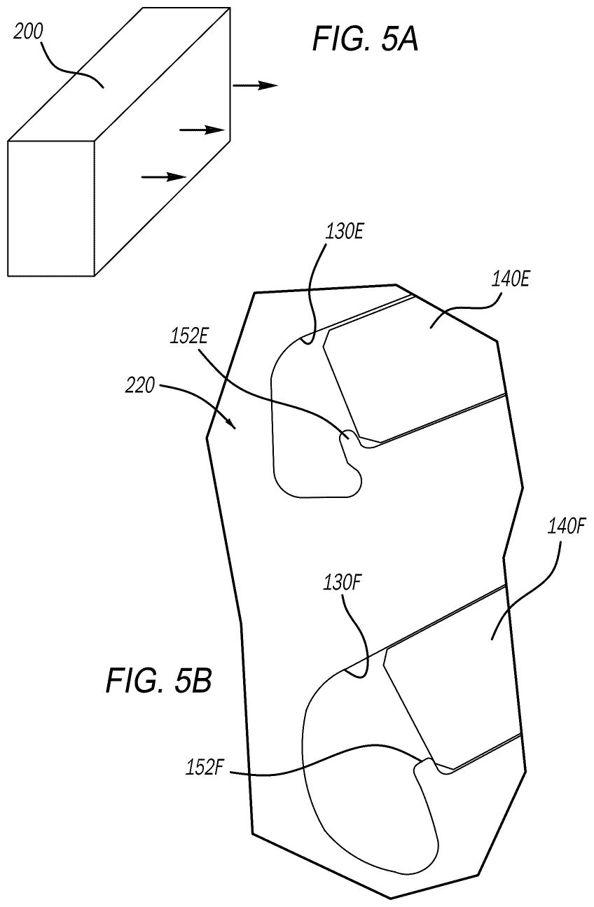

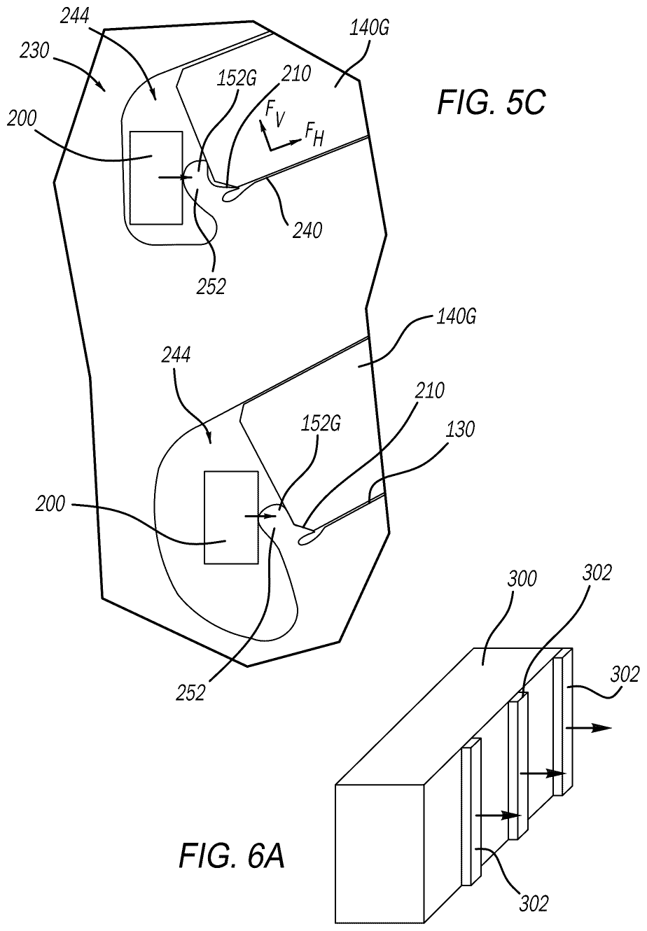

With reference now to FIGS. 5A-5C, additional features of the present disclosure will be described. FIG. 5A is a front perspective view of a first auxiliary tool 200 used to urge a wedge shaped retention mechanism 210 (FIG. 5C) provided a retention body 152G between the magnet 140G and the rotor lamination 120. FIG. 5B is a plan view of a first lamination layer 220 in the rotor lamination stack 100. The first lamination layer 220 presents a geometry that does not interface with the first auxiliary tool 200 of FIG. 5A. In particular, the lamination pattern 220 includes bodies 152E and 152F that generally extend into the respective slots 130E and 130F that are configured to not deflect into the magnets due to advancement of the first auxiliary tool 200. It will be appreciated that the first auxiliary tool 200 may be configured with different geometries to interact specifically to complementary geometries of various lamination layers depending upon the application.

As shown in FIG. 5C, a second lamination layer 230 is provided in the rotor lamination stack 100. The second lamination layer 230 presents a geometry that does interface with the first auxiliary tool 200 of FIG. 5A. The first auxiliary tool 200 of FIG. 5A deflects a retention mechanism 152G toward the magnet 140G such that the wedge 210 creates a load in two directions F_{V} and F_{H} between the magnet 140G and an edge 240 the rotor slot 130. In examples, the first auxiliary tool 200 is inserted into a magnet pocket 244, applying load to deform only the wedge shape end associated with the second lamination layer 230. As shown, the retention mechanism 152G includes a generally protruding body portion 252 that extends into the magnet pocket 244 for interfacing with the first auxiliary tool 200.

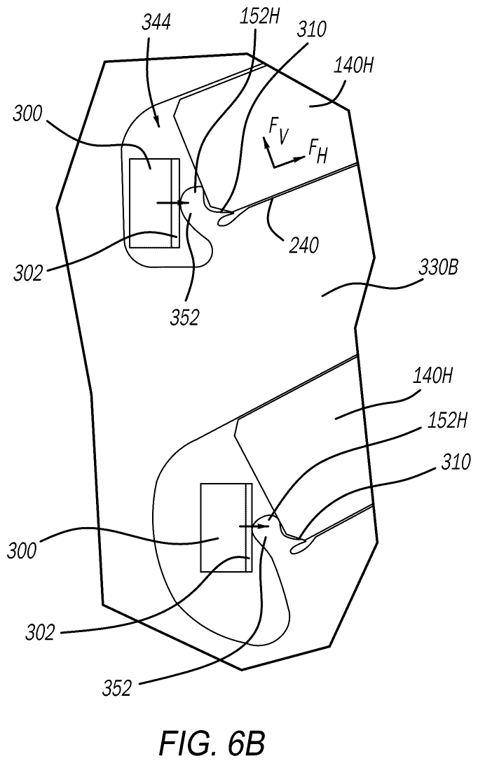

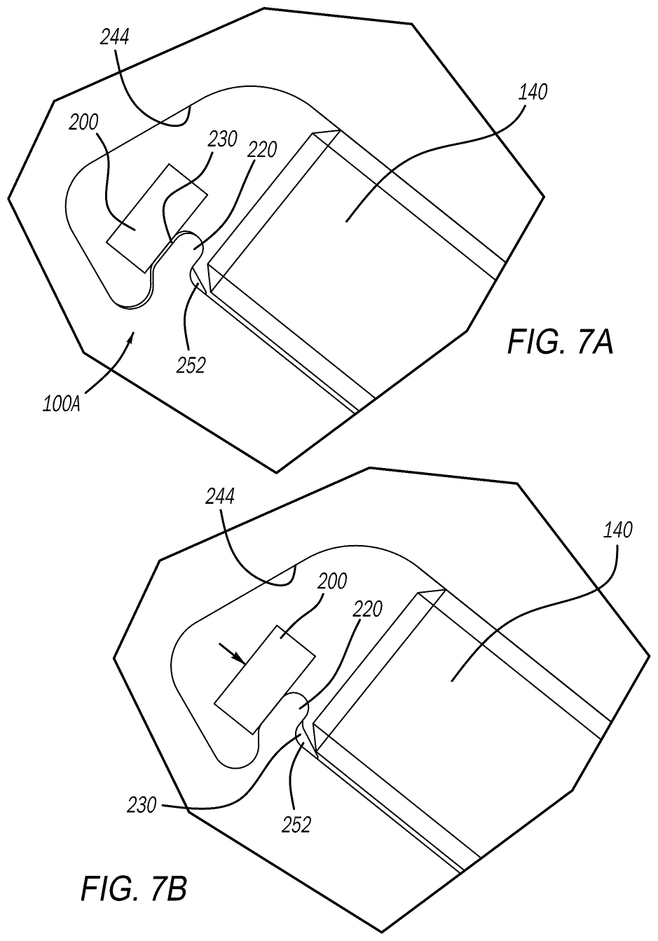

With reference now to FIGS. 6A-6B, additional features of the present disclosure will be described. FIG. 6A is a front perspective view of a second auxiliary tool 300 used to urge a wedge shaped retention mechanism 310 (FIG. 6B) provided on retention mechanism 152H between the magnet 140H and the rotor lamination 330B. The second auxiliary tool 300 includes a plurality of steps 302 protruding therefrom. As shown in FIG. 6B, the auxiliary tool 300 of FIG. 6A deflects the retention mechanism 152H toward the magnet 140H such that the retention mechanism 310 creates a load in two directions F_{V} and F_{H} between the magnet 140H and an edge 240 of the rotor slot 130. In examples, the second auxiliary tool 300 is inserted into a magnet pocket 344. The second auxiliary tool 300 deflects only the first lamination layers aligned with the steps 302 such that the retention mechanisms on the first lamination layers deflect toward the magnet and the first lamination layers not aligned with the steps remain unmoved. As shown, the retention mechanism 152H includes a generally protruding body portion 352 that extends into the magnet pocket 244 for interfacing with the steps 302 of the auxiliary tool 300. With the configuration described herein, supplemental retention, such as mold injection 144 (FIG. 1) is not needed. As can be appreciated, eliminating mold injection is a substantial cost savings.

FIG. 7A is a plan view of a section of a rotor lamination stack 100A including a first lamination layer 220 and a second lamination layer 230, wherein the first auxiliary tool 200 is positioned adjacent the second lamination layer 230 before deflection of the retention mechanism 252 on the second lamination layer 232 toward the magnet. FIG. 7B is a plan view of the section of the rotor lamination stack 100A of FIG. 7A and shown subsequent to the first auxiliary tool 300 deflecting only the second lamination layer 230 such that the retention mechanism 252 on the second lamination layer 230 deflects toward the magnet 140 and the first lamination layer 220 remains unmoved.

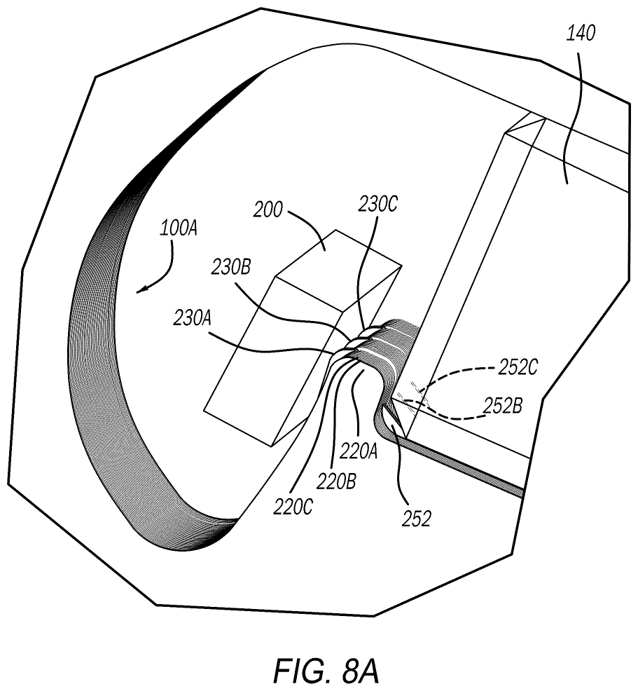

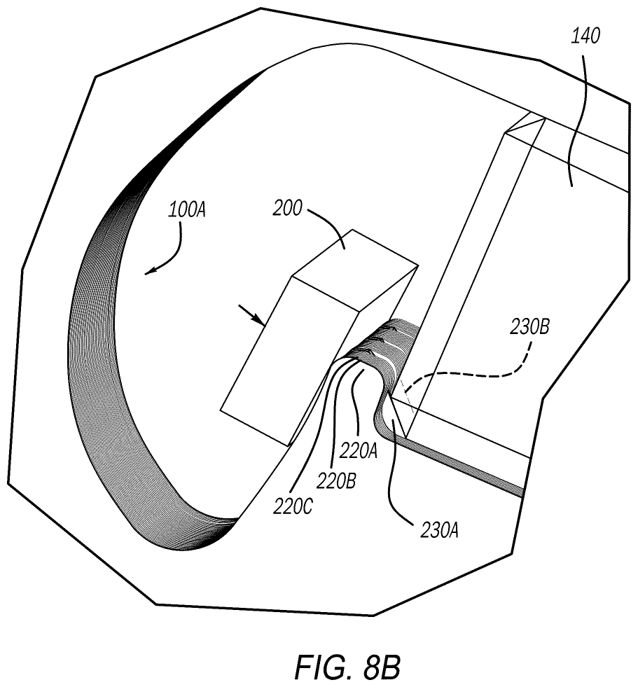

FIG. 8A is a plan view of a section of a rotor lamination stack 100A including a plurality of first lamination layers 220A, 220B, 220C, and second lamination layers 230A, 230B, 230C, wherein the first auxiliary tool 200 is positioned adjacent the plurality of second lamination layers 230A, 230B before deflection of the retention mechanisms 252A, 252B, 252C etc., on the second lamination layers 230A, 230B, 230C, toward the magnet 140.

FIG. 8B is a plan view of the section of a rotor lamination stack 100A shown in FIG. 8A, subsequent to the first auxiliary tool 200 deflecting only the second lamination layers 230A, 230B, 230C such that the retention mechanisms 252A, 252B, 2352C on the second lamination layers 230A, 230B, 230C deflect toward the magnet and the first lamination layers remain unmoved;

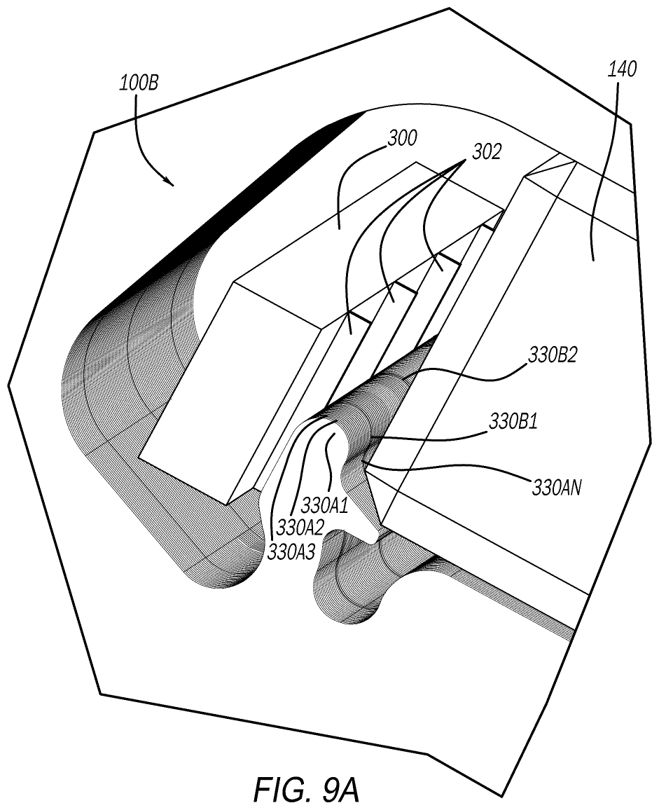

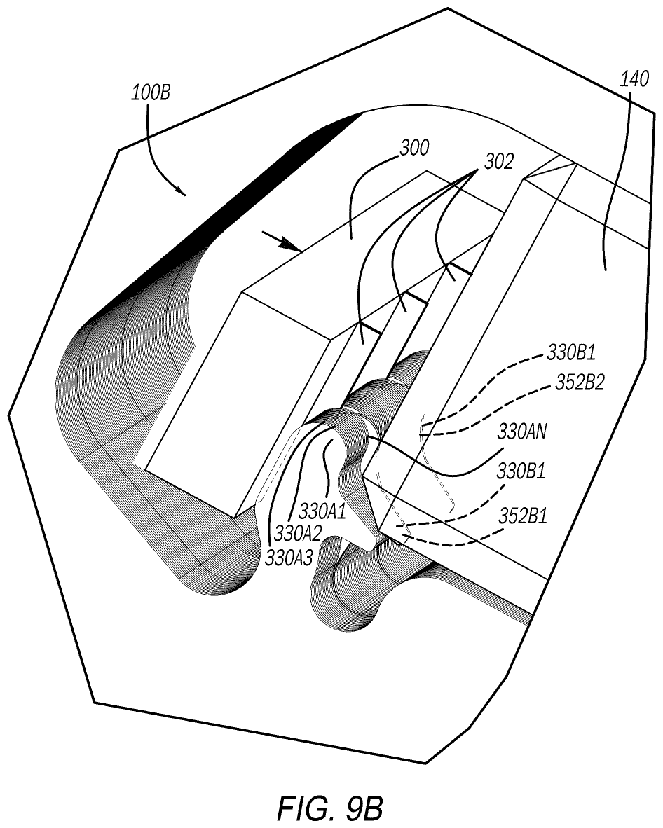

FIG. 9A is a plan view of a section of a rotor lamination stack 100B including a plurality of first lamination layers 330A1, 330A2, 330A3, 330AN, wherein a second auxiliary tool 300 is positioned adjacent the plurality of first lamination layers, the second auxiliary tool 300 having steps 302 configured thereon before deflection of the selected retention mechanisms 330B1, 330B2, on the first lamination layers toward the magnet 140; and

FIG. 9B is a plan view of the section of a rotor lamination stack 100B shown in FIG. 9A, subsequent to the second auxiliary tool 100B deflecting only the first lamination layers aligned with the steps 302 of the second auxiliary tool 300 such that the retention mechanisms 352B1, 352B2, etc., on the aligned first lamination layers 330B1, 330B2 deflect toward the magnet 140 and the first lamination layers 330A1, 330A2, 330A3, 330AN not aligned with the steps remain unmoved.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric machine for powering an electric vehicle, the electric machine comprising:
a rotor configured to rotate relative to a stator to drive a rotor shaft and at least one drive wheel of the electric vehicle, the rotor defining at least a first rotor slot configured to receive a magnet therein;
a plurality of first rotor laminations stacked upon each other each having a first pattern; and
a plurality of second rotor laminations each having a second pattern, distinct from the first pattern, the plurality of second rotor laminations each having a retention mechanism defined thereon;
wherein the plurality of second rotor laminations are configured to deflect upon advancement of an auxiliary tool into the plurality of second rotor laminations at the respective retention mechanisms, the respective retention mechanisms deflecting into the magnet creating a retention load retaining the magnet within the rotor slot.

2. The electric machine of claim 1, wherein the auxiliary tool comprises a first auxiliary tool, wherein the plurality of first rotor laminations do not deflect upon the advancement of the first auxiliary tool into the plurality of second rotor laminations.

3. The electric machine of claim 2, wherein the plurality of first rotor laminations outnumber the plurality of second laminations.

4. The electric machine of claim 1, wherein the second rotor lamination defines an edge at the rotor slot, wherein the retention mechanism deflects causing the retention load of the magnet against the edge.

5. The electric machine of claim 1, wherein the auxiliary tool is configured to be advanced in a direction parallel to the rotor slot and into the respective retention mechanisms.

6. The electric machine of claim 1, wherein a second rotor lamination of the plurality of second rotor laminations is interleaved between multiple first rotor laminations of the plurality of first rotor laminations.

7. The electric machine of claim 1, wherein the plurality of second rotor laminations align and deflect upon the advancement, wherein the first rotor laminations do not deflect upon the advancement of the auxiliary tool.

8. A method for assembling a rotor configured for use in an electric motor for powering and electric vehicle, the rotor configured to rotate relative to a stator to drive a rotor shaft and at least one drive wheel of the electric vehicle, the rotor defining at least a first rotor slot configured to receive a magnet therein, the method comprising:
arranging a plurality of first rotor laminations stacked upon each other, each having a first pattern;
arranging a second rotor lamination between adjacent first rotor laminations of the plurality of first rotor laminations, the second rotor lamination having a second pattern distinct from the first pattern, the second pattern including a retention mechanism defined thereon that extends generally into the first rotor slot;
inserting the magnet into the rotor slot; and
advancing an auxiliary tool toward the first and second rotor laminations, wherein the plurality of second rotor laminations are deflected upon the advancing, the respective retention mechanisms deflecting into the magnet creating a retention load retaining the magnet within the rotor slot.

9. The method of claim 8, wherein the auxiliary tool comprises a first auxiliary tool, wherein the plurality of first rotor laminations do not deflect upon the advancing of the first auxiliary tool into the plurality of second rotor laminations.

10. The method of claim 9, wherein the plurality of first rotor laminations outnumber the plurality of second laminations.

11. The method of claim 8, wherein the second rotor lamination defines an edge at the rotor slot, wherein the retention mechanism deflects causing the retention load of the magnet against the edge.

12. The method of claim 8, wherein the auxiliary tool is configured to be advanced in a direction parallel to the rotor slot and into the respective retention mechanisms.

13. The method of claim 1, wherein a second rotor lamination of the plurality of second rotor laminations is interleaved between multiple first rotor laminations of the plurality of first rotor laminations.

14. An electric machine for powering an electric vehicle, the electric machine comprising:
a rotor configured to rotate relative to a stator to drive a rotor shaft and at least one drive wheel of the electric vehicle, the rotor defining at least a first rotor slot configured to receive a magnet therein;
a plurality of rotor laminations stacked upon each other each having a first pattern, the plurality of rotor laminations each having a retention mechanism defined thereon; and
wherein less than all of the plurality of rotor laminations are configured to deflect upon advancement of an auxiliary tool into the plurality of rotor laminations, the respective retention mechanisms deflecting into the magnet creating a retention load retaining the magnet within the rotor slot.

15. The electric machine of claim 14, wherein the auxiliary tool comprises steps configured thereon, wherein the less than all of the plurality of rotor laminations comprises a predetermined amount of laminations that align with the steps and deflect upon the advancement.
